(19) United States
(12) Patent Application Publication
(10) Pub. No.: US 2010/0023740 A1
(43) Pub. Date: Jan. 28, 2010

(54) DIAGNOSTIC UTILITY AND METHOD FOR A DATA STORAGE DEVICE

(75) Inventors: John Edward Moon, Superior, CO (US); Paul Francis Kusbel, Longmont, CO (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts, CA (US)

(21) Appl. No.: 12/178,215

(22) Filed: Jul. 23, 2008

(51) Int. Cl. G06F 9/24; G06F 12/00

(52) U.S. Cl. 713/2; 711/115; 711/E12.001

(57) ABSTRACT

The disclosure is related to systems and methods of a diagnostic utility for a data storage device. Further, the present disclosure is also related to monitoring host activity and storing information related to the host activity in a nonvolatile cache of a data storage device. In a particular embodiment, a method includes monitoring a host computer for an occurrence of data storage device related activity and storing information based on the data storage device related activity in a nonvolatile memory of a removable data storage device.

### FIELD OF THE DISCLOSURE

The present disclosure is generally related to a diagnostic utility for a data storage device. Further, the present disclosure is also related to monitoring host activity and storing information related to the host activity in a nonvolatile cache of a data storage device.

### BRIEF DESCRIPTION OF THE DRAWINGS

FIG. 1 is a diagram of an illustrative embodiment of a system with a diagnostic utility for a data storage device;

FIG. 2 is a diagram of another illustrative embodiment of a system with a diagnostic utility for a data storage device; and

FIG. 3 is a flow diagram of an embodiment of a method of monitoring a host for diagnostic information related to a data storage device.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

When communication fails between a host computer and a data storage device, it can be difficult to determine the cause of the communication failure. Often, the data storage device is considered the cause of the communication failure and returned to the manufacturer. However, the data storage device manufacturer may have an inability to determine if the communication failure was caused by the data storage device or the host computer when the communication failure can not be duplicated; thus, possibly preventing the data storage device manufacturer from identifying and fixing the root cause of the communication failure. This disclosure provides solutions to these problems by implementing systems and methods having a diagnostic utility to monitor a host and and record information to a data storage device. The recorded information may be analyzed after a host or data storage device failure to help determine a cause of the failure.

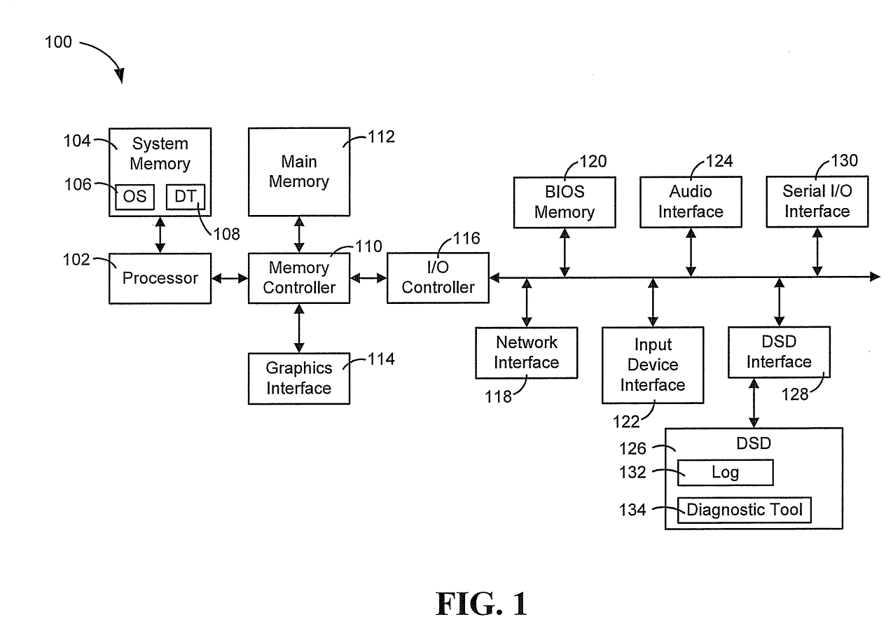

Referring to FIG. 1, a particular embodiment of a computer system is shown and generally designated 100. In a particular embodiment, the computer system 100 can be a desktop computer, a laptop, a server, a personal digital assistant (PDA), a telephone, a music player, another electronic device, or any combination thereof. The computer system 100, or host, may include a central processing unit (CPU) 102. While CPU 102 may be a processor, controller, digital signal processor, reduced instruction set computer (RISC), application specific integrated circuit (ASIC), and the like. Although shown with one CPU 102, the computer system 100 may may alternatively include multiple processing units. The CPU 102 may be connected to a system memory 104. The system memory 104 may be used to store an operating system module 106 and a diagnostic utility module 108 (a diagnostic tool). In a particular embodiment, the system memory 104 may be a random access volatile memory, such as synchronous dynamic random access memory (SDRAM). System memory 104 may optionally be any type of high speed memory device or memory circuitry.

The CPU 102 may also be coupled to a memory controller 110 that can be coupled to a main memory 112 and a graphics interface 114. The memory controller 110 provides an interface to allow the CPU 104 or other devices to access the main memory 112. The main memory 112 may be volatile random access memory (RAM) and can be composed of one or more memory modules. The memory controller 110 includes logic for mapping addresses to and from the CPU 102 and other devices to particular areas of the main memory 112. The graphics interface 114 may include a video controller (not shown) and video memory (not shown) that may be connected to a display. The memory controller 110 handles communications between the CPU 102, the main memory 112, the graphics interface 114, and an input/output (I/O) controller 116 that is coupled to the memory controller 110.

The I/O controller 116 provides an interface for the CPU 104 to access other devices, such as a network interface 118, a basic input output system (BIOS) memory 120, various input devices such as a keyboard or mouse via an input device interface 122, an audio speaker or microphone via an audio interface 124, a data storage device 126 via a data storage device interface 128, and serial I/O devices via a serial I/O interface 130. The BIOS memory 120 may be flash memory or read-only-memory (ROM) and can contain the firmware code to initialize the BIOS and the hardware of the computer system 100 and load the operating system 106.

The data storage device interface 128 may be any interface that allows attachment of data storage devices. In a particular embodiment, the data storage device interface 128 comprises an interface that allows attachment of a disc drive, such as USB, IEEE 1394, SATA, eSATA PATA, SCSI, SAS, or Fiber Channel. The data storage device 126 may be internal or external to a case of the computer system 100. In another embodiment, the I/O controller 116 and the data storage device interface 128 may include logic to support attaching a redundant array of independent discs (RAID); thus, the data storage device 126 may comprise a RAID.

In a particular embodiment, the data storage device 126 may include a log 132 and a diagnostic tool 134. The data storage device 126 may be any type of data storage device, including a solid state storage device, a disc drive storage device, or a hybrid data storage device. A hybrid data storage device as discussed herein is a data storage device having both a magnetic recording medium and a nonvolatile solid state storage medium. In a particular embodiment, the data storage device 126 is removable (i.e. disconnectable) from the computer system 100.

During operation, the firmware from the BIOS memory 120 may be loaded when the computer system 100 is powered-on or reset. The firmware may initialize the BIOS and load the diagnostic utility module 108 into the system memory 104. In a particular embodiment, the computer system 100 may receive the diagnostic utility module 108 from the data storage device 126. The diagnostic utility module 108 can monitor the computer system 100 for an occurrence of data storage device related activity and store information based on the data storage device related activity in a nonvolatile memory of the data storage device 126.

In one embodiment, the diagnostic utility module may be loaded as part of the BIOS. In another embodiment, the BIOS may execute the diagnostic utility module 108 to perform the monitoring of the computer system 100 and the storing of the information in the data storage device 126. The information based on the data storage device related activity may be stored in the log 132 of the data storage device 126 in real-time. In a particular embodiment, the log 132 may be stored in a nonvolatile solid state memory medium of the data storage device 126. The information recorded in the log 132 of the data storage device 126 may include any information useful to determine an error of the computing system 100 and/or the data storage device 126.

In a particular embodiment, the BIOS loads the diagnostic utility module 108 prior to the operating system 106 being loaded. Once the operating system is loaded, the diagnostic utility module 108 can monitor the computer system 100 independent of the operation of the operating system 106 for the occurrence of data storage device related activity. The diagnostic utility module 108 can also store the information based on the data storage device related activity in a nonvolatile memory of the data storage device 126 independent of the operating system 106.

The diagnostic utility module 108 may monitor for data storage device related activity that may include communication between the data storage device 126 and other components of the computer system 100, including read requests, write requests, status requests, test requests, or other data storage device interface commands. Other data storage device related activity that may be monitored may also include network activity of the computer system 100, data bus activity of the computer system 100, operations performed by the operating system 106, applications executed by the operating system 106, and data access requests to another data storage device other than the data storage device 126.

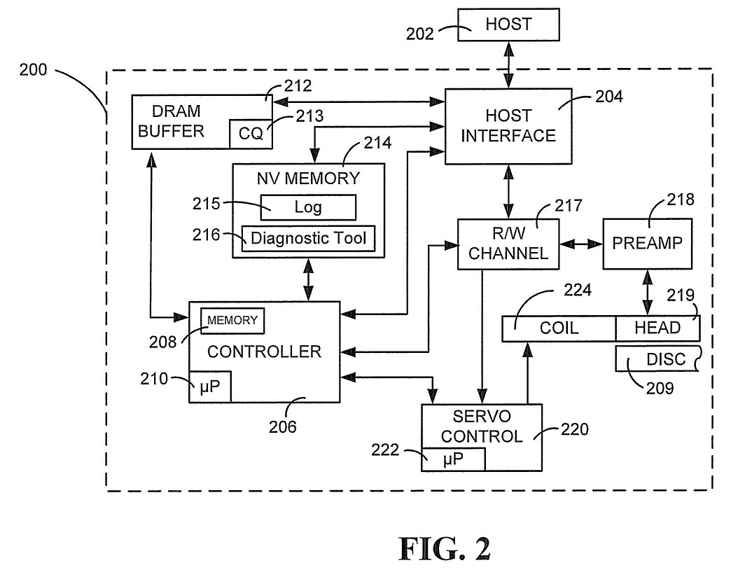

Referring to FIG. 2, a particular embodiment of a data storage device is shown and generally designated 200, the data storage device 200 may be used as the data storage device 126 shown in FIG. 1. Specifically, FIG. 2 provides a functional block diagram of a hybrid data storage device. The data storage device 200 can communicate with a host device 202 (such as the computer system 100 shown in FIG. 1) via a hardware/firmware based interface circuit 204. The data storage device 200 includes a programmable controller 206 with associated memory 208 and processor 210. The programmable controller 206 may be coupled to a buffer 212. The buffer 212 can temporarily store user data during read and write operations and can include a command queue (CQ) 213 where multiple pending access operations can be temporarily stored pending execution.

Further, FIG. 2 further shows the data storage device 200 to include a read/write (R/W) channel 217 which encodes data during write operations and reconstructs user data retrieved from disc(s) 209 during read operations. A preamplifier/driver circuit (preamp) 218 applies write currents to the head(s) 219 and provides pre-amplification of readback signals.

A servo control circuit 220 uses servo data to provide the appropriate current to the coil 224 to position the head(s) 219. The controller 206 can communicate with a processor 222 to move the head(s) 219 to the desired locations on the disc(s) 209 during execution of various pending commands in the command queue 213.

In a particular embodiment, the programmable controller 206 may also be coupled to a nonvolatile solid state memory 214. The nonvolatile solid state memory 214 may be used as a buffer/cache or as addressable memory by the programmable controller 206. In addition, the nonvolatile solid state memory 214 may allow direct memory access from the host via the interface circuit 204.

The nonvolatile solid state memory 214 may include a log file 215, such as the log 132 shown in FIG. 1, that can be reserved to store information received from the host 202 that may be useful to determine an error of the host 202 or the data storage device 200. The log file 215 may also store information about the data storage device 200 that may be useful to determine an error of the host 202 or the data storage device 200. In a particular embodiment, the information may include an indication of an action performed by the host 202 or the data storage device 200, a date of the action, a time of the action, results of the action, a program requesting the action, a data type related to the action (such as a requested file type), or any other information that may be useful to determine an error. In another particular embodiment, the information may include an indication of data traffic between the host 202 and the data storage device 200. The indication of data traffic may include indications of read or write requests, indications of bandwidth usage of a data bus between the host 202 and the data storage device 200, indications of operating system activity at the host, such as which programs are performing operations and/or what operations are performed.

In another particular embodiment, the nonvolatile solid state memory 214 may include a diagnostic tool 216, such as the diagnostic utility module 134 shown in FIG. 1. The diagnostic tool 216 may be provided to the host 202 upon request, such as a request from the BIOS or provided to the BIOS upon a triggering action, such as an initialization of the data storage device 200 by the BIOS. The diagnostic tool may include program code executable by a processor, for example the CPU 104 shown in FIG. 1, to allow the diagnostic tool to run independently of an operating system of the host 202 and record information about the activity of the host 202, information about the activity of an operating system of the host 202, or information about the activity of the data storage device 200.

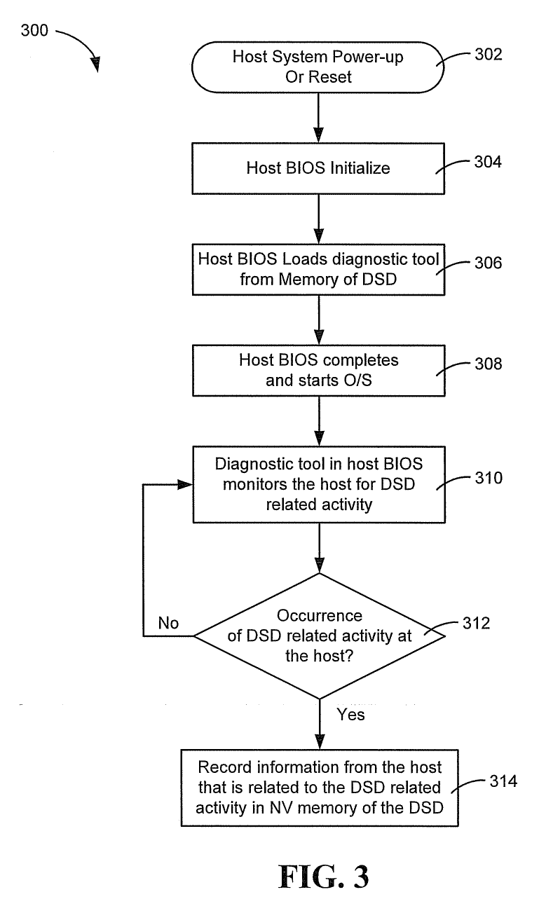

Referring to FIG. 3, a flow diagram of an embodiment of a method of monitoring a host for diagnostic information related to a data storage device is shown and generally designated 300. The method 300 may include powering-up or resetting a host system, such as computer system 100 shown in FIG. 1 or host 202 shown in FIG. 2, at 302. Prior to loading an operating system to the host, the host BIOS initializes, at 304, by loading firmware from a BIOS memory.

Once the BIOS has initialized, the BIOS can load a diagnostic utility into a system memory of the host, at 306. The BIOS may load the diagnostic utility from a memory of a removable data storage device, such as the data storage device 126 shown in FIG. 1 or the data storage device 200 shown in FIG. 2. After the diagnostic utility is loaded, the BIOS then completes and loads an operating system for the host, at 308. In an alternative embodiment, the diagnostic utility may be loaded by the host at a time other than at power-on or reset, as long as the diagnostic utility is loaded independent of the operating system and can be executed independent of the operating system.

In a particular embodiment, the BIOS may execute the diagnostic utility to monitor the host for data storage related activity, at 310. Once the operating system is loaded, the diagnostic utility may monitor the host for the occurrence of data storage device related activity independent of the operation of the operating system. The diagnostic utility may monitor the host for data storage device related activity that may include communication between the data storage device and other components of the host, including read requests, write requests, status requests, test requests, or other data storage device interface commands. Other data storage device related activity that may be monitored may also include network activity of the host, data bus activity of the host, operations performed by the operating system, applications executed by the operating system, and data access requests to another data storage device.

When the diagnostic utility detects an occurrence of a data storage device related activity, at 312, the diagnostic utility may store information related to the data storage device related activity in a nonvolatile memory of the data storage device, at 314. In a particular embodiment, the nonvolatile memory may be a nonvolatile solid state memory, such as flash memory. The diagnostic utility can also store the information in the nonvolatile memory of the data storage device independent of the operating system. In a particular embodiment, the information may be stored in real time to the nonvolatile memory of the data storage device; thus, allowing information to be retained if there is power loss or host system failure. The information recorded in the nonvolatile memory of the data storage device may include any information useful to determine an error of the host and/or an error of the data storage device.

In a particular embodiment, the information useful to determine an error may include an indication of an action performed by the host or the data storage device, a date of the action, a time of the action, results of the action, a program requesting the action, a data type related to the action (such as a requested file type), or any other information that may be useful to determine an error. In another particular embodiment, the information may include an indication of data traffic between the host and the data storage device. The indication of data traffic may include indications of read or write requests, indications of bandwidth usage of a data bus between the host and the data storage device, indications of operating system activity at the host, such as which programs are performing operations and/or what operations are performed. The information may also include an indication of activity of other components of the host, such as input or output devices, other storage devices, network devices, audio devices, or video devices. The information may also include status, usage, and test results of other memory of the host, such as system memory or main memory

In accordance with various embodiments, the methods described herein may be implemented as one or more software programs running on a computer processor or controller, such as the CPU 102, the memory controller 110, or the controller 206. Dedicated hardware implementations including, but not limited to, application specific integrated circuits, programmable logic arrays and other hardware devices can likewise be constructed to implement the methods described herein. The systems and methods described herein are particularly useful for data storage devices having nonvolatile solid state memory; however, the systems and methods described herein can be applied to any type of data storage system.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
monitoring a host computer for an occurrence of data storage device related activity; and
storing information based on the data storage device related activity in a nonvolatile memory of a removable data storage device.

2. The method of claim 1 further comprising:
initializing a Basic Input Output System (BIOS); and
loading a diagnostic utility to perform the monitoring of the host computer.

3. The method of claim 2 further comprising receiving the diagnostic utility from the removable data storage device.

4. The method of claim 3 wherein the diagnostic utility is loaded as part of the BIOS.

5. The method of claim 3 wherein the BIOS executes the diagnostic utility to perform the monitoring of the host computer and the storing of the information.

6. The method of claim 5 further comprising:
loading an operating system on the host computer;
wherein the diagnostic utility is loaded prior to an operating system being loaded; and
wherein the diagnostic utility monitors the host computer independent of the operation of the operating system.

7. The method of claim 6 further comprising storing the information in the removable data storage device in real-time.

8. The method of claim 1 wherein the data storage device activity comprises communication between the host and the removable data storage device.

9. The method of claim 1 wherein the data storage device activity comprises network activity of the host.

10. The method of claim 1 wherein the data storage device activity comprises bus activity of the host.

11. The method of claim 1 wherein the data storage device activity comprises operations performed by the operating system.

12. The method of claim 1 wherein the data storage device activity comprises applications executed by the operating system.

13. The method of claim 1 wherein the data storage device activity comprises access requests to a data storage device other than the removable data storage device.

14. The method of claim 1 wherein the removable data storage device is selected from one of a solid state memory device; a disc drive; and a hybrid data storage device.

15. A system comprising:
a controller;
a memory coupled to the controller; and
a diagnostic utility module comprising a set of instructions stored in the memory and executable by the controller to:
monitor a host computer of the controller for an occurrence of data storage device related activity; and
store information based on the data storage device related activity in a nonvolatile memory of a removable data storage device.

16. The system of claim 15 wherein the diagnostic utility module further comprises instructions to:
monitor the host computer independently from an operating system; and
store the information independently from the operating system to a log in a nonvolatile memory of the removable data storage device.

17. The system of claim 16 further comprising:
wherein a Basic Input Output System (BIOS) of the host computer is initialized prior to loading the diagnostic utility module in the memory; and
wherein the diagnostic utility module is loaded from the nonvolatile memory of the removable data storage device;
wherein an operating system is loaded on the host computer after the diagnostic module is loaded to the memory and executed by the controller;

18. A computer readable medium having instructions to cause a processor to perform a method comprising:
monitoring a host computer for an occurrence of data storage device related activity; and
storing information based on the data storage device related activity in a nonvolatile memory of a removable data storage device.

19. The computer readable medium of claim 18 further having instructions to cause a processor to perform a method comprising:
monitoring the host computer independently from an operating system; and
storing the information independently from the operating system to a nonvolatile memory of the removable data storage device

20. The computer readable medium of claim 18 further having instructions to cause a processor to perform a method comprising:
storing the information in the nonvolatile memory in real time.
